(19) United States
(12) Patent Application Publication
(10) Pub. No.: US 2009/0269459 A1
(43) Pub. Date: Oct. 29, 2009

(54) Cold Fillable, Storable Water-and-Oil Emulsion

(75) Inventor: Franciscus Maria Josephus Cleophas, Zetten (NL)

Correspondence Address: BROWDY AND NEIMARK, P.L.L.C.;624 NINTH STREET, NW, SUITE 300, WASHINGTON, DC, 20001-5303, US

(73) Assignee: Smart-Food Technology B.V., Zetten (NL)

(21) Appl. No.: 12/085,365

(22) PCT Filed: Nov. 17, 2006
(86) PCT No.: PCT/NL2006/000577

§ 371 Date: May 22, 2008

(30) Foreign Application Priority Data
Nov. 22, 2005 (NL) 1030483

(51) Int. Cl. A23D 7/00; A23L 1/39

(52) U.S. Cl. 426/589; 426/602; 426/392

(57) ABSTRACT

The present invention relates to a water-and-oil emulsion, in particular in the form of a sauce or soup, the emulsion comprising at least: an aqueous phase; a fat phase; a food acid or an acidity regulator in the form of one or more weak acids or derivatives thereof, preferably chosen from the group which consists of lactic acid, citric acid, malic acid and acetic acid; where the emulsion has a pH of 4.6 or higher, has an Aw value between 0.601 and 100.0, is suitable for being filled cold, and where the percentage of dissolved substances in the aqueous phase is 0-54.9 vol %.

The present invention relates to a water-and-oil emulsion, in particular in the form of a sauce or soup.

The person skilled in the art understands what is meant by a water-and-oil emulsion, so this term does not need to be further explained here. An embodiment of a water-and-oil emulsion is described in U.S. Pat. No. 5,958,476.

A general characteristic of a sauce or a soup is that they can be used as an independent meal component, a drink, a snack, or as a dessert.

In the case of sauces one can of course think of savory meal sauces such as tomato sauce or béchamel sauce, but also of sweet and/or dairy-based sauces such as vanilla custard and fruit quark or a sauce based on fruit puree for example.

In the case of soups one can think of savory soups, such as curry soup or cream of chicken soup, but also of juice or drinks such as chocolate drinks or a dairy drink based for example on buttermilk.

The invention is applicable both to products which can be kept at ambient temperature and to products which can be kept refrigerated. The invention is less preferably applicable to products which are kept in the freezer.

When unrefrigerated storage is desired, in the case of the soups and sauces that aye known the method of preservation that is usually chosen is sterilization of the soup or sauce in the package or, instead of this, warm filling of the soup or sauce in the package. One of the instances known in the prior art is WO 02/05659, which describes the technique of warm filling by means of examples.

A significant disadvantage of warm filling is that the product remains warm for a long time in the package, which leads to a typical ‘cooked flavor’, a product which does not look appetizing, or even breaking of the emulsion in the product. A second significant disadvantage of warm filling is that any presence of microorganisms in the product after production and packaging, in the form of vegetative cells or bacterial, spores, will inevitably lead to spoilage of the product during the storage of the product.

In the case of other sauces that are known, for the preservation thereof use is made of a high degree of acidity (i.e. low pH), with use usually being made of an acidity regulator system which comprises an acid or a combination of acids, possibly with the salt of these acids. By definition these sauces have a pH range of 4.6 or lower. These sauces can be filled cold, without there being any need for sterilization of the product in the package. Among the instances known in the prior art are WO 92/07474, U.S. Pat. No. 4,840,806 and JP 05207886, in which pH ranges between 3.5 and 4.5 are described in combination with the technique of cold filling.

A significant disadvantage of the preservation of sauces using a high degree of acidity, which can also be used for soups, is that sauces preserved in this way often have a sour taste, which is usually due to the acidity regulation system that is used to make the sauces (or soups) storable. It has been found that the consumer does not really like such a sour taste. A second disadvantage of the preservation of sauces and/or soups using a high degree of acidity is that in sauces of this type it is often impossible to incorporate herbs or ground spices. Dried herbs and ground spices often contain considerable numbers of microorganisms or bacterial spores, which if incorporated into ingredients of this type may lead to spoilage of the product during the storage of the product.

Sweet sauces are often stored in the refrigerator so as to improve the storage life (pasteurized vanilla custard for example), or they may be stored outside the refrigerator (UHT-treated yoghurt drink for example). A significant disadvantage of pasteurized products is the very limited storage life, even if the product is stored in the refrigerator.

Another known form of soups and sauces that are known with a long. storage life is sauces and soups which are present in a package in concentrated or dry form.

A disadvantage of sauces and soups in dry form is that they have to be diluted with water by the consumer himself, which is regarded as inconvenient. In addition it is found in practice that it is sometimes difficult to add the right amount of water to the dry soup or sauce and that the formation of lumps cannot always be prevented.

An example of a soup in concentrated form is known in the prior art under GB 113507070 for example, which describes a concentrated soup which is prepared with hot water before use. Users may find this inconvenient. The ready-to-use emulsion according to the invention is easy to use and has a long storage life, and only needs to be warmed up—if desired—before use. It is thus not necessary to mix the sauce with water for example—a fact which benefits the ease of use.

A further disadvantage in the prior art is the limited application of, in particular, milk powders and proteins. This is largely due to the presence of contamination that is typical of the products, in milk powders for example, by vegetative microorganisms and bacterial spores. Another source of vegetative microorganisms and bacterial spores, as already mentioned earlier, is for example dried herbs and ground spices. According to the prior art at present, products in which ingredients of this type are incorporated have a short storage life (i.e. 3 months or less if stored under refrigeration or 3 months or less if stored at room temperature), have to be heated for a long time, or have to be processed at such a low pH that the ingredients lose their functionality in the form of improvement of flavor, consistency and eating properties. It is inter alia the purpose of the present invention to solve this problem and thus increase the applicability of ingredients of this type.

For all foods with a high moisture content it is true that moulds, yeasts, enteric bacteria, other vegetative bacteria, aerobic bacterial spores and anaerobic bacterial spores are the most important causes of microbiological spoilage during storage. A number of pathogenic microorganisms axe also known, among which, without being limiting, salmonella, clostridia, bacillus cereus, staphylococcus aureus and E. coli are additionally regarded as relevant in the area of the prior art in question.

Experts in this field know that microorganisms grow best at pH values around 7.0, and only a few microorganisms grow below pH values of 4.0. pH ranges of 4.6 or higher are regarded as favorable for the growth and development of bacteria that cause spoilage (Escherichia coli, clostridium botulinum and staphylococcus aureus for example); with pH values of 4.8 or higher being regarded in particular as especially favorable.

In general it is true that bacteria are more sensitive to the effects of pH than moulds and yeasts.

The water activity or Aw value of the product is also an important value which gives an indication of the growth conditions for microorganisms in foods with a high moisture content. The Aw value, also called the water activity, is a measure of the amount of free water that is present in the product. By definition the Aw value of water is 1. Most bacteria that cause spoilage or disease can grow or develop at an Aw value of 0.90 or higher. Moulds and yeasts can start to grow or develop at an Aw value of 0.60 or more. According to the prior art at present, the growth and development of moulds and yeasts in cold-filled products is usually prevented by adding sorbic acid or one of the salts of sorbic acid, which may or may not be replaced by, or combined with, benzoic acid or salts of benzoic acid.

Spore-forming bacteria or other spore-forming microorganisms thus constitute a significant risk for the products with a high moisture content of the type that is discussed here. Spores of bacteria can be found in ambient air, water and in commonly used ingredients such as skimmed milk powder, dried herbs and ground spices (such as ground pepper, ground nutmeg and ground cloves for example). Although ingredients of this type can offer major advantages when used in foods (more particularly advantages with regard to taste and appearance), the suitability of these ingredients is limited in products with a high moisture content, in view of the relatively high levels of contamination with vegetative bacteria and spores of microorganisms that are typical of products of this kind. The spores of microorganisms are able to survive heat treatments such as pasteurization and sterilization and thus cause microbiological spoilage during the storage and distribution of these products.

It is an object of the present invention to avoid one or more of the above-mentioned or other problems.

It is a further object of the present invention to provide a new, preferably ready-to-use, water-and-oil emulsion, in particular in the form of a soup or sauce (sweet or savory), with a good storage life, while at the same time guaranteeing an agreeable flavor profile.

The present inventor has now surprisingly found that when certain levels of spoilage-causing bacteria are determined in water-and-oil emulsions after packaging (examples of which, without being limiting, are vegetative aerobic bacteria, spore-forming aerobic bacteria and spore-forming anaerobic bacteria), these bacteria are not able to grow or develop and thus cause spoilage of the products, even though the conditions for development of microorganisms (expressed as pH, Aw value and storage temperature for example) were favorable or very favorable. On the contrary: the microbiological activity stabilized or decreased during storage, with (virtually) sterile products arising under certain conditions, four to sixteen weeks after production.

Comparable results were found after the products were stored for 5, 10 and 15 days consecutively at 30° C. and in products which were stored for 4, 7 and 10 days at 37° C. Once again it was found that the level of microbiological activity stabilized or decreased, or (virtually) sterile products arose after the end of the tests.

In general it was found that when samples of products were put into keeping quality tests with increased temperature and were found to be microbiologically stable, these samples were still microbiologically stable a few months after the end of the tests.

Further comparable good results were found after storage of products under refrigerated conditions (minimum 0.1° C., maximum 12° C., with an optimum of 4-7° C.), with products being storable preferably for Longer than 3 months, more preferably for longer than 6 months, and even more preferably for 12 months or longer.

The invention can be characterized in a first aspect by a water-and-oil emulsion, in particular in the form of a sauce or soup, with the emulsion comprising at least:
an aqueous phase;
a fat phase;
a food acid or an acidity regulator in the form of one or more weak acids or derivatives thereof;
a optionally an emulsifier;

where the emulsion has a pH of 4.6 or higher and an Aw value of 0.601-100, the emulsion is suitable for being filled cold, and where the percentage of dissolved or dispersed substances in the aqueous phase is 0-54.9 vol % of the aqueous phase.

As described above, it has been found that the emulsion according to the present invention gives a greatly improved storage life both for products stored under refrigeration and for products that can be kept outside the refrigerator, such as ready-to-use sauces and soups.

A water-in-oil emulsion (w-i-o) means in the art that there is a continuous fat phase, with the aqueous phase of the emulsion consisting of aqueous droplets which are dispersed in the oil phase. A water continuous phase, such as in the case of an oil-in-water emulsion (o-i-w), contains the oil. phase as dispersed droplets. An intermediate form of water-and-oil distribution is referred to as a bicontinuous emulsion. In a bicontinuous emulsion part of the aqueous phase is not dispersed. This can be determined by means of the conductivity. A complete fat-continuous emulsion has a conductivity of 0 microSiemens. Tap water has a conductivity of at least 1000 microSiemens, depending on the quantity of dissolved ions. A bicontinuous emulsion can contain up to 90 vol % non-dispersed water, preferably up to 80%, more preferably up to 70% and even more preferably up to 60%. Especially preferable is a content up to 50%, preferably 40%. The emulsion is preferably a w-i-o emulsion. The entire range of w-i-o, o-i-w and bicontinuous emulsions is referred to as water-and-oil emulsions. Bicontinuous emulsions according to the invention can have a conductivity of >150, preferably >300, more preferably >500 microsiemens.

A further known problem in the use of the water-and-oil emulsion technology, in particular when the fat phase occurs as the continuous or bicontinuous phase, is the occurrence of emulsion instability during storage and distribution. Emulsions of this type tend to destabilize, for example due to the effect of time or as a result of fluctuations in temperature during storage and distribution of the products. Destabilization of emulsions of this type occurs in particular when this technology is applied in combination with a high proportion of aqueous phase (i.e. a low proportion of fat). Destabilization also occurs when ingredients are used which have a destabilizing effect on the emulsion, such as milk or milk powder for example. When this type of emulsion destabilizes (for example as a result of phenomena known under the English terms flocculation, coalescence or so-called Ostwald ripening), relatively big water droplets are formed which make it possible for microorganisms and/or spores of microorganisms to grow or develop. Normally speaking, these problems are solved by working with relatively low pH values. It is known that microbiological contamination of the aqueous phase of products of this kind has a limiting effect on the storage life of products of this kind. It is also known that emulsions of this kind in the classical form destabilize as a result of storage at increased temperature and as a result of temperature fluctuations during storage. These problems are also overcome with the aid of the present invention.

In the Applicant's opinion, as has been said, the surprising results are largely attributable to the use of a water-and-oil emulsion, where the emulsion comprises an aqueous phase and a fat phase and where furthermore the aqueous phase contains a food acid or an acidity regulator in the form of one or more weak acids or derivatives thereof, where an emulsifier is optionally used, and where the percentage of dissolved or dispersed substances in the aqueous phase is 0-54.9 vol % of the aqueous phase.

The specific composition of the emulsion, and in particular the use of a water-and-oil emulsion together with an acidity regulator, contributes significantly to the striking observation that microorganisms or spores of microorganisms that are present cannot grow or develop, even though the primary conditions for growth, expressed as pH, Aw value, storage temperature and percentage of water in the aqueous phase, can be regarded as favorable.

It has been found that the preserving capacity of the product is strong enough to control or decrease any contamination with microorganisms or spores of microorganisms that is present, or even to reduce it to a virtually sterile product during storage and distribution.

The present invention improves existing techniques and technologies by:

Making it possible for food producers to use the cost-effective cold filling technique for ready-to-use meal components that have a high moisture content, with it being possible to make use of pH, Aw value, aqueous phase levels, storage temperatures and storage time limits which until now have been regarded as unsuitable for guaranteeing microbiological stability.

Making it possible for food producers to make use of ingredients contaminated with microbiological spores, such as dried herbs, ground spices and milk powder, with improvements in flavor, appearance and cost effectiveness, whereas this has until now not been regarded as possible with products of this type.

Improving production and storage life tolerances for known applications of oil-and-water emulsions.

In general improving the microbiological storage life of foods with a high moisture content by making use of this technique.

A further advantage of the emulsion according to the present invention is that it does not need to be subjected to a sterilization step in the package. Nor does the emulsion need to be filled warm. It has been found that this benefits the appearance and flavor of the sauce or soup obtained. It has furthermore been found that no specific barrier requirements need to be set for the package or packaging environment employed. The use of aseptic forms of packaging, such as described in EP 0832566 and WO 02/05659, is therefore not necessary.

The water-and-oil emulsion according to the present invention comprises an aqueous phase which is intended to give the emulsion a suitable liquidity, so that it can more easily be poured over a food product to be garnished, such as vegetables or meat, can be eaten as a soup, or in some other way becomes immediately suitable for the intended use as an independent meal component, snack, dessert or drink.

The aqueous phase can in addition to water contain further components such as herbs, spices, sugars, vegetable proteins, animal proteins, flavors, flavorings, colorants, etc.

The fat phase can contain one or more oils or fats as used in the food industry.

The fat phase can contain one or more oils or fats as used in the food industry. In one embodiment the fat phase contains an oil and/or fat selected from animal fats such as milk fat, butter fat or fish oil. for example, or from vegetable fats such as cocoa butter, coconut oil, canola oil, maize oil, palm oil, soya oil, olive oil, peanut oil, safflower oil, cottonseed oil, palm kernel oil, rapeseed oil and sunflower oil for example, or fractions or mixtures thereof, which may or may not be hardened or transesterified. The fat phase preferably contains an oil and/or fat selected from milk fat, butter fat, maize oil, palm oil, soya oil, rapeseed oil or sunflower oil, or fractions or mixtures thereof, which may or may not be hardened or transesterified, with greater preference for palm oil, soya oil, rapeseed oil or sunflower oil, or fractions or mixtures thereof, which may or may not be hardened or transesterified. Especially preferred are oils or fats or mixtures of oils and fats, which may or may not be hardened or transesterified, where the melting point of the fat is higher than 25° C., and preferably higher than 30° C., with greater preference for a melting point higher than 35° C. More especially preferred is the use of hardened soya 36, hardened soya 42, hardened palm 44 or the use of a mixture of palm stearin with a liquid vegetable oil chosen from the group soya oil, rapeseed oil or sunflower oil, with preference for the use of sunflower oil, in the ratio palm stearin:sunflower oil from 90:10 to 1.0:90, preferably 80:20 to 20:80, even more preferably 70:30 to 30:70. The suitability for application of the fat phase can, without being limiting, be expressed in the NMR value at 20° C. (N20), 30° C. (N30), 35° C. (N35) and 40° C. (N40). In one embodiment there is a preference for an oil or fat or a composition of oils and fats with the following values: N20=0-99, N30=0-99, N35=0-99 and N40=0-99, with greater preference for N20=15-99, N30=10-99, N35=5-99 and N40=0.5-99, and with even greater preference for N20=30-99, N30=12.5-99, N35 =5.5-99 and N40=1.0-99. NMR values can be determined in accordance with ISO 8292 or IUPAC 2 150, known in laboratories equipped for this purpose; where the values found give an indication of the percentage of solidified (i.e. undissolved) fat crystals at a given temperature. An antioxidant known in the food industry can optionally be added to the fat phase.

Emulsifiers known in the food industry can be used as the emulsifier. If use is made of an emulsifier, emulsifiers with an HLB value of 3-1.8 are preferred, with preference for emulsifiers with an HLB value of 3-9, and with even greater preference for emulsifiers with an HLB value of 3-6. The HLB value gives an indication of the functionality of the emulsifier and can for example be determined by the Griffin or Davies method. Emulsifiers can be applied in the present invention in a range of 0-5 vol % emulsifier, with preference for 0.01-3 vol % emulsifier, with preference for 0.2-2 vol % emulsifier, relative to the total volume of the emulsion. In the choice of the type of emulsifier, without being limiting, there is a preference for so-called monoglycerides, combinations of mono- and diglycerides, polyglycerol esters of glycerides, lactic acid esters of glycerides and citric acid esters of glycerides, all of which may or may not be in combination with lecithin. Examples of suitable emulsifiers (all available from Danisco Netherlands) are: dimodan PVP, dimodan HP, dimodan LS, Dimodan OT, Grindsted PGE 55, Grindsted lactem P 22 and Grindsted Citrem N12.

Sorbic acid or benzoic acid can be used as an additional. preservative, in the form of the free acid or in the form of the salt thereof, or a combination thereof. Other preservative components are also possible, however. It should be noted here that addition of the sorbic acid and/or benzoic acid regarded as a preservative is not necessary for guaranteeing the desired storage life, and certainly not when the emulsion has a pH higher than 4.6.

The acidity regulator used according to the invention includes in one embodiment at least one weak acid, in the free form or derivative form (salt) thereof. The acid can thus consist of citric acid, lactic acid or acetic acid. Other acids can also be used. In general, weak organic acids that are permitted for food applications can be used.

A weak acid is generally defined in the prior art as an acid which does not completely dissociate into a proton and its conjugated base in water.

In another embodiment the acidity regulator used comprises at least two different weak acids, in the free acid form or derivative form thereof. The acidity regulator can thus for example comprise citric acid in combination with lactate (i.e. the salt derivative of lactic acid) The person skilled in the prior art will quickly understand that the acidity regulator can comprise further components.

According to a preferred embodiment of the emulsion according to the invention, preferably if unrefrigerated storage is desired, at least one of the weak acids or derivatives is chosen from the group which consists of lactic acid, citric acid, malic acid and/or acetic acid. In a further preferred embodiment of the emulsion according to the invention, at least two of the weak acids or derivatives thereof are chosen from the group which consists of lactic acid, citric acid, malic acid and acetic acid. The acidity regulator here preferably comprises at least a combination of acids or derivatives thereof which is chosen from: citric acid and lactic acid; malic acid and lactic acid; citric acid, malic acid and lactic acid; lactic acid and acetic acid; citric acid, lactic acid and acetic acid; malic acid, lactic acid and acetic acid; and citric acid, malic acid, lactic acid and acetic acid.

It has been found that an improved storage life, in combination with a mild flavor profile, can be obtained in this way.

Highly desired results are obtained when the emulsion contains 0.01.-1.0 vol % citric acid and 0.10-1.0 vol % lactic acid, preferably 0.02-0.50 vol % citric acid and 0.02-0.50 vol % lactic acid, relative to the emulsion.

Favorable results are also obtained when the emulsion contains 0.01-1.0 vol % malic acid and 0.10-1.0 vol % lactic acid, preferably 0.02-0.50 vol % malic acid and 0.02-0.50 vol % lactic acid, relative to the emulsion.

It is also to be preferred when the emulsion contains 0.01-1.0 vol % citric acid, 0.01-1.0 vol % malic acid and 0.01-1.0 vol % lactic acid, preferably 0.02-0.50 vol % citric acid, 0.02-0.50 vol % malic acid and 0.02-0.50 vol % lactic acid, relative to the emulsion.

It is also favorable when the emulsion contains 0.01-1.0 vol % lactic acid and 0.01-1.0 vol % acetic acid, preferably 0.02-0.50 vol % lactic acid and 0.02-0.50 vol % acetic acid, relative to the emulsion..

According to an alternative preferred embodiment the emulsion contains 0.01-1.0 vol % citric acid, 0.01-1.0 vol % lactic acid and 0.01-1.0 vol % acetic acid, preferably 0.02-0.50 vol % citric acid, 0.02-0.50 vol % lactic acid and 0.02-0.50 vol % acetic acid, relative to the emulsion.

According to a further alternative embodiment the emulsion contains 0.01-1.0 vol % malic acid, 0.01-1.0 vol % lactic acid and 0.03-1.0 vol % acetic acid, preferably 0.02-0.50 vol % malic acid, 0.02-0.50 vol % lactic acid and 0.02-0.50 vol % acetic acid, relative to the emulsion.

It is furthermore preferable if the emulsion contains 0.01-1.0 vol % citric acid, 0.01-1.0 vol % malic acid, 0.01-1.0 vol % lactic acid and 0.01-1.0 vol % acetic acid, preferably 0.02-0.50 vol % citric acid, 0.02-0.50 vol % malic acid 0.02-0.50 vol % lactic acid and 0.02-0.50 vol % acetic acid, relative to the emulsion.

According to the present invention the emulsion has a pH in a range of 4.6-7.5, preferably 4.8-7.0, more preferably 5.0-6.5, and even more preferably 5.01-6.5. If exclusively unrefrigerated storage is desired, within this pH range there is a preference for a pH value of 4.6-7.0, with preference for 4.8-6.5, with greater preference for 5.0-6.5, and with even greater preference for 5.01-6.5.

If it is intended to store the sauce or the soup under refrigeration, within the already stated range of 4.6-7.5 a preference arises for a pH value of 4.8-7.0, with a preference for a pH of 5.0-7.0, and with even greater preference fox a pH value of 5.01-6.5.

A very good storage life of the sauce can be obtained in this way.

It has furthermore been found to be favorable for obtaining a desired texture of the emulsion if the aqueous phase makes up 10-99.5 vol %, preferably 41-99.5 vol %, more preferably 61-99.5 vol %, even more preferably 75-99.5 vol %, especially preferably 80-99.5 vol % of the sauce. A favorable effect is also observed if the percentage of water in the aqueous phase is 46.0-99.5%, preferably 50.0-99.5%, more preferably 65.0-99.5%, even more preferably 75.0-99.5%.

It is furthermore preferable according to the invention if the percentage of water-soluble or water-dispersible components in the aqueous phase is 0-54.9%, preferably 0.1-45.0%, more preferably 1-35.0%, even more preferably 3-25.0%. In one embodiment 0.1-54.9 vol %, preferably 0.2-45 vol %, more preferably 0-35 vol % even more preferably 0.3-20 vol %, most preferably 0.5-10 vol % water-soluble or water-dispersible sugars are added to the aqueous phase in the form of monosaccharides, disaccharides, polysaccharides, derivatives of mono-, di- or polysaccharides and combinations thereof. A number of non-limiting examples of water-soluble or water-dispersible components include sucrose, glucose, fructose, dextrose, maltose and maltodextrins (such as so-called low-DE maltodextrins for example) and vegetable gums such as xanthan gum, guar gum, carob meal or starches such as potato starch, wheat starch, maize starch and modified starches for example. Oils and fats belonging to the fat phase are not regarded as water-dispersible components.

In a preferred embodiment according to the present invention, up to 15 vol %, preferably up to 12.5 vol %, more preferably up to 7.5 vol %, even more preferably up to 5 vol % proteins are added to the aqueous phase in the form of vegetable proteins, milk proteins, whey proteins, other animal. proteins or combinations thereof. A number of non-limiting examples of vegetable proteins include treated and untreated soya proteins and proteins of legumes such as lupins and peas. The terms milk proteins and whey proteins refer to proteins obtained from milk. Milk proteins and whey proteins can be added in the form of fresh milk, buttermilk, whey or other sources which contain these proteins, such as for example milk powder based on whole, semi-skimmed or skimmed milk, whey powders or other powders which contain milk proteins or whey proteins. A number of non-limiting examples of animal proteins include proteins originating from eggs (these include for example proteins obtained from the egg white, the yolk or the whole egg) and other animal proteins (fox example albumins obtained from blood serum) Within this range there is a preference for the use of vegetable and animal proteins obtained from soya, peanuts, milk and whey proteins and animal. proteins obtained from eggs, with greater preference for vegetable and milk and whey proteins, and with even greater preference for the application of milk and whey proteins.

It is furthermore to be preferred according to the present invention if the emulsion has an Aw value of 0.601-1.00, preferably 0.801-1.000, more preferably 0.901-0.995, even more preferably 0.950-0.995. The “Aw value” is a quantity which is known pew se in the prior art and can be used as an indicator to estimate the storage life of products. It is thus true in general that products with a low Aw value have a good storage life. The use of for example an increased dosage of salt or sugars in a product reduces the Aw value and thus improves the storage life of a product. One of the instances known in the prior art is the already mentioned WO 02/056591, in which the use of increased quantities of salt and sugars is described. These increased quantities of salt and sugars of course have an effect on the flavor of the product. The present invention makes it possible to make products with an Aw value which, simply by virtue of this Aw value, is suitable for the growth of microorganisms, while a good storage life can nevertheless be guaranteed.

The Aw value can for example be determined with the aid of an instrument which is customary for this purpose, a so-called Novisana 2000 (obtainable from Pedak, Heythuijsen, Netherlands).

The emulsion according to the present invention can be produced by the simple mixing of the components, in which operation either a cold process or a process including a heating step can be used, as desired. If a heating step is used, the mixed components are preferably heated to a temperature of 25-150° C., with greater preference for a temperature of 30-130° C., after which the emulsion is cooled back to a temperature of 0-55° C. The emulsion can then be filled in the desired package. The emulsion is more preferably heated to a temperature of 65-110° C., in particular 80-95° C., after which the emulsion is cooled back to a temperature of 0-55° C.

The emulsion is preferably filled cold in the package, i.e. at a temperature <55° C., preferably <40° C., with even greater preference for a filling temperature <30° C.

Furthermore it benefits the flavor and appearance of the emulsion if the emulsion is not sterilized in the package.

In another aspect the present invention relates to a package provided with the emulsion according to the invention. The package is usually made from plastic or glass.

The invention will now be explained in greater detail on the basis of a number of non-limiting examples.

Storage life and microbiological stability were determined on the basis of analyses carried out by an accredited laboratory. Analyses for total aerobic count (carried out by a method equivalent to ISO 4833), yeasts and moulds (carried out by a method equivalent to ISO 7954), enterobacteriaceae (carried out by a method equivalent to ISO 7402), aerobic spores and anaerobic spores (carried out by a method equivalent to NEN 6567) were regarded as most relevant.

To validate the present invention for protection against pathogenic microorganisms, without being limiting, analyses were carried out at random for salmonella (carried out by a method equivalent to NEN EN 12824), Staphylococcus aureus (carried out by a method equivalent to ISO 6888), Bacillus cereus (carried out by a method equivalent to ISO 7932) and E. coli (carried out by one of the laboratory's own methods, based on ISO 16649).

Samples were regarded as microbiologically stable or with good keeping quality if the analytical values after the end of the defined keeping quality tests for aerobic count were <1,000,000, preferably <300,000, more preferably <100,000, even more preferably <50,000, and most preferably <5,000. For both aerobic and anaerobic spores, values of <100,000, preferably <50,000, more preferably <10,000, even more preferably <1,000 were considered to be a sign of microbiological stability. For all the other microbiological values described analytical values of <1,000, preferably <100, were considered to be favorable, with the exception of the analyses for salmonella, where exclusively the absence of salmonella in 25 grams (i.e. “not detectable”) was considered to be favorable.

In several tests skimmed milk powder was used, sometimes in combination with significant amounts of ground spices. The ingredients used were analyzed before use, with contamination with vegetative bacteria, aerobic spores and anaerobic spores being detected at the usual levels for such types of ingredients.

For validation purposes several tests were used with the object of verifying the test results and test procedures. Some of these tests showed spectacular results; fox example:

A product was made using all the usual ingredients, with the exception of potassium sorbate or some other comparable preservative (e.g. benzoate). The product was filled under ambient (i.e. not controlled-environment) packaging conditions. A few days after production contamination with vegetative bacteria, aerobic and anaerobic spore-formers was determined. Surprisingly, no contamination with moulds and yeasts was found, although Aw value, pH and storage temperature were favorable for growth and the most common barrier against moulds and yeasts (sorbic acid or. comparable) was absent. During keeping quality tests the contamination found decreased to (virtually) sterile after four to sixteen weeks. In tests with increased temperature (30° C. and 37° C.) the product remained (virtually) sterile for 15 (30° C.) and 4 days (37° C.), respectively.

### EXAMPLE 1

A quantity of 100 kg of emulsion in the form of a meal sauce was prepared by mixing the following components:

72.500 kg of water;

17.275 kg of fat phase with emulsifier (Eureka II [main components: soya oil and/or sunflower oil, and/or rapeseed oil, and/or palm oil and/or fractions of palm oil, which were or were not transesterified or (partially) hardened, or mixtures thereof (typical NMR value of the fat mixture used: N20=55%, N30=20%, N35=10%, N40=5%; for all the stated values there was a typical tolerance of +/−5%), emulsifier (typical HLB value 3-6], obtained from Cleophas foodsolutions, Zetten, Netherlands);
0.010 kg of antioxidant;
0.175 kg of lactic acid 50% (Chemproha);
0.800 kg of common salt;
2.500 kg of granulated sugar;
0.150 kg of potassium sorbate;
2.000 kg of skimmed milk powder (1%);
4.000 kg of maize starch (obtained from Amylum, Aalst, Belgium);

0.300 kg of mixed-herbs for béchamel sauce (made up of about 50 vol % of ground black pepper and about 50 vol % of ground nutmeg, obtained from Unifine, Puttershoek, Netherlands);

0.150 kg of bouillon powder (Probase flavor high impact, obtained from Givoudan, Netherlands).

The components were mixed for 5 minutes at 70° C. in a Nauta mixer (obtainable from Hosakawa Micron, Doetinchem, Netherlands). The sauce was then warmed up to a temperature of about 90° C. with the aid of a Gerstenberg heat exchanger (obtainable from Gerstenberg & Aggez, Brondby, Denmark). After that the sauce was cooled to a temperature of 15° C. Finally the sauce was filled under ambient (i.e. not controlled-environment) packaging conditions in a package without specific barrier properties.

The sauce had a pH value of 5.3 and an Aw value of about 0.985. The result was an attractive sauce which had a mild flavor. The sauce also showed good microbiological stability for 12 months at 20° C., 15 days at 30° C. and 10 days at 37° C.

### EXAMPLE 2

A quantity of 1.00 kg of meal sauce was prepared by mixing the following components:
73.000 kg of water;
13.725 kg of fat phase with emulsifier (Eureka II; Cleophas foodsolutions);
0.175 kg of lactic acid 50% (Chemproha);
0.400 kg of common salt;
0.150 kg of sorbate;
2.000 kg of skimmed milk powder (1%);
0.050 kg of vanilla extract;
6.500 kg of granulated sugar;
4.000 kg of maize starch (Amylum).

The components were mixed for 5 minutes at 70° C. in a Nauta mixer. The sauce was then warmed up to a temperature of about 90° C. with the aid of a Gerstenberg heat exchanger. After that the sauce was cooled to a temperature of 18° C. Finally the sauce was filled under ambient (i.e. not controlled-environment) packaging conditions in a package without specific barrier properties.

The sauce had a pH value of 5.3 and an Aw value of about 0.985. The result was an attractive sauce which had a mild flavor. The sauce also showed good microbiological stability for 12 months at 20° C., 15 days at 30° C. and 10 days at 37° C.

### EXAMPLE 3

A quantity of 100 kg of meal sauce was prepared by mixing the following components:
72.500 kg of water;
13.725 kg of fat phase with emulsifier (Eureka II; Cleophas foodsolutions);
0.100 kg of lactic acid 50% (Chemproha);
0.050 kg of citric acid (Chemproha);
0.400 kg of common salt;
0.150 kg of sorbate;
2.500 kg of skimmed milk powder (1%);
0.050 kg of vanilla extract;
5.500 kg of maldex 150 (maltodextrin, producer Tate & Tyle; supplied by Brenntag, Netherlands);
4.000 kg of maize starch (Amylum).

The components were mixed for 5 minutes at 70° C. in a Nauta mixer. The emulsion was then warmed up to a temperature of about 130° C. with the aid of a Gerstenberg heat exchanger. After that the emulsion was cooled to a temperature of 12° C. and filled. Finally the sauce was filled under ambient (i.e. not controlled-environment) packaging conditions in a package without specific barrier properties.

The sauce had a pH value of 5.3 and an Aw value of about 0.985. The result was an attractive sauce which had a mild flavor. The sauce also showed good microbiological stability for 12 months at 20° C., 15 days at 30° C. and 10 days at 37° C.

1. Water-and-oil emulsion, comprising:
an aqueous phase;
a fat phase; and
a food acid or an acidity regulator in the form of one or more weak acids or derivatives thereof;
wherein the emulsion has a pH of 4.6 or higher and an Aw value between 0.601 and 100.0, and is suitable for being filled cold, and wherein the percentage of dissolved substances in the aqueous phase is 0-54.9 vol %.

2. Emulsion according to claim 1, wherein the fat phase forms the continuous or the bicontinuous phase.

3. Emulsion according to claim 1, wherein the emulsion is a water-in-oil emulsion.

4. Emulsion according to claim 1, wherein the food acid or the acidity regulator contains at least one weak acid in the free acid form or derivative form thereof.

5. Emulsion according to claim 1, wherein the food acid or the acidity regulator contains two different weak acids in the free form or derivative form thereof.

6. Emulsion according to claim 1, wherein the food acid or the acidity regulator is selected from the group consisting of lactic acid, citric acid, malic acid and acetic acid.

7. Emulsion according to claim 1, wherein the acidity regulator contains at least a combination of acids or derivatives thereof which is selected from the group consisting of: citric acid and lactic acid; malic acid and lactic acid; citric acid, malic acid and lactic acid; lactic acid and acetic acid; citric acid, lactic acid and acetic acid; malic acid, lactic acid and acetic acid; and citric acid, malic acid, lactic acid and acetic acid.

8. Emulsion according to claim 1, wherein the emulsion has a pH in the range of 4.6-7.5.

9. Emulsion according to claim 1, wherein the aqueous phase makes up 10-99.5 vol % of the emulsion.

10. Emulsion according to claim 1, wherein it has an Aw value of 0.601-1.000.

11. Emulsion according to claim 1, wherein the percentage of water-soluble or water-dispersible components in the aqueous phase is 0-54.9%.

12. Emulsion according to claim 1, wherein the percentage of water in the aqueous phase is 46.0-99.5%.

13. Emulsion according to claim 1, wherein 0-54.9 vol % water-soluble or water-dispersible sugars are added to the aqueous phase in the form of monosaccharides, disaccharides, polysaccharides, derivatives of mono-, di- or polysaccharides and combinations thereof.

14. Emulsion according to claim 1, wherein 0-15 vol % proteins are added to the aqueous phase in the form of vegetable proteins, milk proteins, whey proteins, other animal proteins or combinations thereof.

15. Emulsion according to claim 1, to which no preservatives have been added.

16. Emulsion according to claim 1, where the emulsion is suitable for being filled cold under ambient conditions.

17. Emulsion according to claim 1, to which an emulsifier has been added.

18. A soup comprising a water-and-oil emulsion of claim 1.

19. A sauce comprising a water-and-oil emulsion of claim 1.

20. Method for producing and packaging a water-and-oil emulsion as defined in claim 1, wherein the ingredients are mixed, optionally while heating, and are cooled back to <55° C.

21. Method according to claim 20, where no sterilization or pasteurization is carried out after filling in the package.

22. Method according to claim 20, wherein the emulsion is filled in a package which is unsuitable for aseptic filling and/or unsuitable for gas packaging.

23. Method according to claim 20, wherein the emulsion is filled cold in the package.

24. Package with an emulsion as defined in claim 1, wherein the emulsion has not been sterilized in the package and has an improved storage life compared with conventional water-and-oil emulsions.

25. Emulsion according to claim 1, wherein the fat phase forms the continuous phase.

26. Emulsion according to claim 1, wherein the emulsion has a pH in the range of 4.8-7.0.

27. Emulsion according to claim 1, wherein the emulsion has a pH in the range of 5.0-6.5.

28. Emulsion according to claim 1, wherein the emulsion has a pH in the range of 5.01-6.5.

29. Emulsion according to claim 1, wherein the aqueous phase makes up 41-99.5 vol % of the emulsion.

30. Emulsion according to claim 1, wherein the aqueous phase makes up 61-99.5 vol % of the emulsion.

31. Emulsion according to claim 1, wherein the aqueous phase makes up 75-99.5 vol % of the emulsion.

32. Emulsion according to claim 1, wherein the aqueous phase makes up 80-99.5 vol % of the emulsion.

33. Emulsion according to claim 1, wherein it has an Aw value of 0.801-1.000.

34. Emulsion according to claim 1, wherein it has an Aw value of 0.901-0.995.

35. Emulsion according to claim 1, wherein it has an Aw value of 0.950-0.995.

36. Emulsion according to claim 1, wherein the percentage of water-soluble or water-dispersible components in the aqueous phase is 0-45.0%.

37. Emulsion according to claim 1, wherein the percentage of water-soluble or water-dispersible components in the aqueous phase is 0-35.0%.

38. Emulsion according to claim 1, wherein the percentage of water-soluble or water-dispersible components in the aqueous phase is 0-25.0%.

39. Emulsion according to claim 1, wherein the percentage of water in the aqueous phase is 50.0-99.5%.

40. Emulsion according to claim 1, wherein the percentage of water in the aqueous phase is 65.0-99.5%.

41. Emulsion according to claim 1, wherein the percentage of water in the aqueous phase is 75.0-99.5%.

42. Emulsion according to claim 1, wherein 0-45 vol % water-soluble or water-dispersible sugars are added to the aqueous phase in the form of monosaccharides, disaccharides, polysaccharides, derivatives of mono-, di- or polysaccharides and combinations thereof.

43. Emulsion according to claim 1,, wherein 0-35 vol % water-soluble or water-dispersible sugars are added to the aqueous phase in the form of monosaccharides, disaccharides, polysaccharides, derivatives of mono-, di- or polysaccharides and combinations thereof.

44. Emulsion according to claim 1, wherein 0-20 vol % water-soluble or water-dispersible sugars are added to the aqueous phase in the form of monosaccharides, disaccharides, polysaccharides, derivatives of mono-, di- or polysaccharides and combinations thereof.

45. Emulsion according to claim 1, wherein 0-10 vol % water-soluble or water-dispersible sugars are added to the aqueous phase in the form of monosaccharides, disaccharides, polysaccharides, derivatives of mono-, di- or polysaccharides and combinations thereof.

46. Emulsion according to claim 1, wherein 0-12.5 vol % proteins are added to the aqueous phase in the form of vegetable proteins, milk proteins, whey proteins, other animal proteins or combinations thereof.

47. Emulsion according to claim 1, wherein 0-7.5 vol % proteins are added to the aqueous phase in the form of vegetable proteins, milk proteins, whey proteins, other animal proteins or combinations thereof.

48. Emulsion according to claim 1, wherein 0-5 vol % proteins are added to the aqueous phase in the form of vegetable proteins, milk proteins, whey proteins, other animal proteins or combinations thereof.

49. A method according to claim 20, wherein the emulsion is filled cold in the package under ambient conditions.
